(19) United States
(12) Patent Application Publication
(10) Pub. No.: US 2015/0287009 A1
(43) Pub. Date: Oct. 8, 2015

(54) SYSTEMS, METHODS, AND DEVICES FOR A COMMON APPLICATION ARCHITECTURE ON MULTIPLE POINT-OF-SALE HARDWARE PLATFORMS TO SUPPORT MULTIPLE APPLICATIONS

(71) Applicant: New Sierra Investments, Haddonfield, NJ (US)

(72) Inventors: Terrance Crowley, Mount Laurel, NJ (US); Amit Chhabra, Mount Laurel, NJ (US)

(21) Appl. No.: 14/681,776

(22) Filed: Apr. 8, 2015

Related U.S. Application Data
(60) Provisional application No. 61/977,043, filed on Apr. 8, 2014.
(60) Provisional application No. 61/977,051, filed on Apr. 8, 2014.

(51) Int. Cl. G06Q 20/20; G06F 9/54

(52) U.S. Cl. CPC G06Q 20/20; G06F 9/54

(57) ABSTRACT

Embodiments of the present disclosure describe systems, methods, and devices for a common application architecture on multiple point-of-sale hardware platforms to support multiple applications. Such embodiments include monitoring, by for an event. Further, embodiments include selecting an application based on the event. In addition, the embodiments include monitoring a transaction implemented by the application based on the event. The monitoring for the event is performed when common application modules are in an idle state. Further, the selecting of the application based on the event is performed when the common application modules are in an application selection state. In addition, the monitoring transaction is performed when the common application modules are in a transaction state. Such embodiments include determining that the transaction is complete then transitioning from a transaction state to an idle state when the transaction is complete.

### CROSS-REFERENCE TO RELATED APPLICATIONS

The present application claims the benefit under the US law and rules including 35 U.S.C. §119(e) from U.S. Provisional Patent Application Ser. No. 61/977,051 filed on Apr. 8, 2014 the entire contents of which is being incorporated herein by reference.

The present application claims the benefit under the US law and rules including 35 U.S.C. §119(e) from U.S. Provisional Patent Application Ser. No. 61/977,043 filed on Apr. 8, 2014 the entire contents of which is being incorporated herein by reference.

The present application is related to U.S. patent application Ser. No. ______ (Attorney Docket No. 5755.118331) titled “Systems, Methods, and Devices for Offering Promotional Materials to Customers by Merchants Using a Point-of-Sale Terminal” filed herewith on the same day as the present application and the entire contents of which is being incorporated by reference.

### BACKGROUND

Point-of-Sale (POS) terminals/devices have been used since the 1970s to conduct purchase transactions when customers/consumers render a payment card (e.g., AMEX, Visa, Mastercard, Discover, etc.) for payment of the purchase. Between the 1970s and the 1990s, POS devices were basic electronic devices with limited processing power and memory. Further, payment card processing technology was vulnerable to fraud. Consequently, security measures were designed and implemented in a variety of forms which increased the complexity of these electronic devices to have more processing power and memory to support security functions to reduce fraud. Also, with the proliferation of the Internet and Internet Protocol (IP) enabled communication coupled with new business opportunities to support additional applications on these devices, these further increased the need for more processing power and memory as well as enhanced displays, and other functionality.

Recognizing the opportunity in electronic payments, an increased number of manufacturers' of POS devices entered the market, each with their own paradigms for executing similar functions, e.g., running a payment transaction, downloading software to a POS device, managing multiple applications on a single device, etc. Thus, POS devices from different manufacturers were not compatible in working with each other. Such a state of the industry locked merchants with a particular POS device vendor/manufacturer for long periods of time because the infrastructure of the POS devices and the network connecting them was in one particular paradigm incompatible with other types of POS devices.

Recently, even more complex security functionality was needed (e.g. EMV Chip Card technology) as well as payment rendering options (e.g. magnetic stripe reader, contact reader, contactless reader, etc.) and provision of non-payment applications (e.g. loyalty customer enrollment programs and gift card redemption, etc.).

Accordingly, there is a need for systems, methods, and devices for a common application architecture on multiple point-of-sale hardware platforms to support multiple applications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention, and explain various principles and advantages of those embodiments.

FIG. 1 is a block diagram of a system for common application architecture on multiple point-of-sale hardware platforms to support multiple applications in accordance with some embodiments.

FIG. 2 is a block diagram of the common application architecture in accordance with some embodiments.

FIG. 3 is a flow diagram of the common application architecture in accordance with some embodiments.

FIG. 4 is a block diagram of the common application architecture in accordance with some embodiments.

FIG. 5 is a state diagram of the common application architecture in accordance with some embodiments.

FIG. 6 is a block diagram of the Idle State monitoring of the common application architecture in accordance with some embodiments.

FIG. 7 is a flow diagram of the Application Selection flow of the common application architecture in accordance with some embodiments.

FIG. 8 is a flow diagram of the Transaction State of the common application architecture in accordance with some embodiments.

FIG. 9 is a flowchart if a method implementing a common application architecture on multiple point-of-sale hardware platforms to support multiple applications in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the disclosure. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts, and accompanying written description. While these details are helpful to explain one or more embodiments, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure describe systems, methods, and devices for a common application architecture on multiple point-of-sale hardware platforms to support multiple applications. Such embodiments include monitoring, by one or more common application modules on a point-of-sale device, for an event. Further, embodiments include selecting, by the one or more common application modules, an application based on the event. In addition, the embodiments include monitoring, by the one or more common application modules, a transaction implemented by the application based on the event. The monitoring for the event is performed when the one or more common application modules are in an idle state. Further, the selecting of the application based on the event is performed when the one or more common application modules are in an application selection state. In addition, the monitoring transaction is performed when the one or more common application modules are in a transaction state. Such embodiments include determining that the transaction is complete and the one or more common application modules transition from a transaction state to an idle state when the transaction is complete. The one or more common application modules are configured to function with one or more POS hardware platforms.

Further embodiments include a point-of-sale (POS) device including a storage device and a processor coupled to the storage device. In addition, the processor is configured to implement one or more common application modules and one or more application modules as well as embed and implement a common application client module within an application module. Moreover, the processor is configured to implement a common application server module that communicates with the common application client module through a common application client Application Programming Interface (API). Also, the processor is configured to implement an idle handler module, a device handler module, and an event handle module each communicating between a POS device hardware platform and the common application server module through a POS device operating system (OS) API. The common application server module is configured to monitor for an event, select an application based on the event, and monitor, the common application client module, a transaction implemented by the application based on the event. The monitoring for the event is performed when the common application server module is in an idle state. Further, selecting of the application based on the event is performed when the common application server module is in an application selection state. In addition, monitoring transaction is performed when the common application server module is in a transaction state. Such embodiments include determining, by the common application server module that the transaction is complete as well as the common application server module transitions from a transaction state to an idle state when the transaction is complete. The one or more common application modules are configured to function with one or more POS hardware platforms.

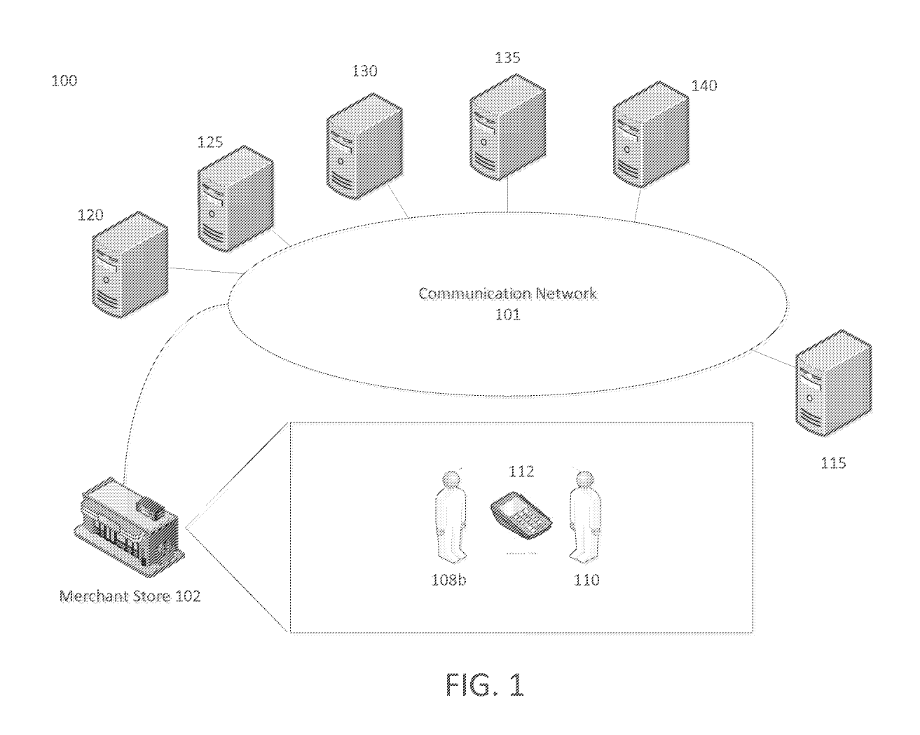

FIG. 1 is a block diagram of a system 100 for common application architecture on multiple point-of-sale hardware platforms to support multiple applications in accordance with some embodiments. Embodiments of the system 100 may include a POS device 112 located in a merchant store 102. A customer 108b may render payment using a payment card at the POS device 112 in the presence of merchant store personnel 110. The POS device 112 may be coupled, over a communication network 101, to a remote computer system 115 operated by the merchant or a (different) third party service provider to process payments rendered at the POS device. A payment application is running on the POS 112 to facilitate the payment transaction. Further, the remote computing system 115 may be coupled to one or several computer servers (120-140) each or a subset of which are owned or operated by the merchant or a third party service provider whose application may be running on the POS device.

Exemplary applications that may be running on the POS device may include, but are not limited to, a customer loyalty application, an inventory management application, sales analytics application, a promotional application, and a social media application. Consequently, referring to FIG. 1, a computer server 120 may facilitate the customer loyalty program. That is, the customer loyalty application running on the POS device 112 may be communicate with the customer loyalty computer server 120 to perform certain functions. One function may be to enroll a customer into the customer loyalty program via the customer loyalty application running on the POS device 112. This includes the customer loyalty application running on the POS device prompting the user for contact information and identification information that is forwarded to the customer loyalty computer server 120 and stored for future use and look-up. Alternatively, a previously enrolled customer may enter identification information (e.g. phone number) into the POS device 112 using the customer loyalty application. Such identification information may be transmitted to the customer loyalty computer server 120. Thereafter, the customer loyalty computer sever 120 looks up the customer account based on the identification information and may record the transaction being conducted at the POS device 112 to credit the customer's loyalty account or offer a promotion to the customer that is transmitted to and displayed by the POS device 112 based on previous transactions.

Further, an inventory management application may be running on the POS device 112. Thus, when a customer purchases a product from the merchant store 102, the application may communicate with an inventory management computer server 125 to notify the sale of the product such that the inventory management computer server 125 adjusts the number of the products in its inventory records and determines whether the inventory of the product has fallen below a threshold such that additional products are needed to be ordered from the manufacturer.

In addition, a sales analytics application may be running on the POS device 112 and may communicate with a sales analytics computer server 130. The POS device 112 may transfer data (e.g. sales of products) such that the sales analytics computer server 130, upon request or automatically, generate reports for the merchant that include hourly, daily, monthly, quarterly, or annual sales reports, product or product category sales reports, sales reports for each salesman, etc.

Moreover, a promotional application may be running on the POS device 112 that, for example, may offer a daily special (e.g. two candy bars for a $1) to the customer. A promotional computer server 135 communicates with the POS device 112 to, inter alia, provide the promotion to the POS device 112, record the number of promotional products during the term of the promotion, etc.

Also, a social media application may be running on the POS device 112. Thus, upon entering social media credentials by the customer, the merchant may notify on the customer's social media account that the customer bought a product at the merchant store 102. Such a notification may be generated by the social media application running on the POS device 112 or may be generated by a social media compute server 140 upon being notified of the customer's purchase transaction and social media credentials.

In some embodiments, certain applications/services may work together. For example, upon a product purchase, a promotion may be offered to a customer's friends through its social media account. In such embodiments, the promotional and social media applications running on the POS device 112 may work in conjunction with each other as well as with the promotional computer server 135 and social media computer server 140.

Thus, a software and hardware platform for the POS device 112 should have the capability to support such applications running on the POS device 112. In addition, there should be a common application architecture to support the different applications running on top of the common application architecture. Moreover, such a common application architecture should be compatible with different hardware platforms of different POS devices such that a merchant e.g. with many stores across a geographic region is not locked into using one POS device manufacturer to supply all their POS devices. Such a common application architecture would allow itself and all other applications supported on top of the common application architecture to be downloaded or otherwise configured onto any type hardware platform of a POS device.

In addition to providing such applications described herein on the POS device 112, the merchant may also provide different mechanisms for a customer to render payment. That is, in some embodiments, the POS device 112 may include a magnetic stripe reader for conventional payment cards, a contact reader, contactless (e.g. NFC) reader, a payment card chip reader (e.g. EMV) or any combination. Further, the POS device 112 may also support different security functions for different payment rendering mechanisms as well as for transmitting purchase transaction information over the communication network 101 to post payments. Such rendering mechanisms and security functions are supported by embodiments of the common application architecture.

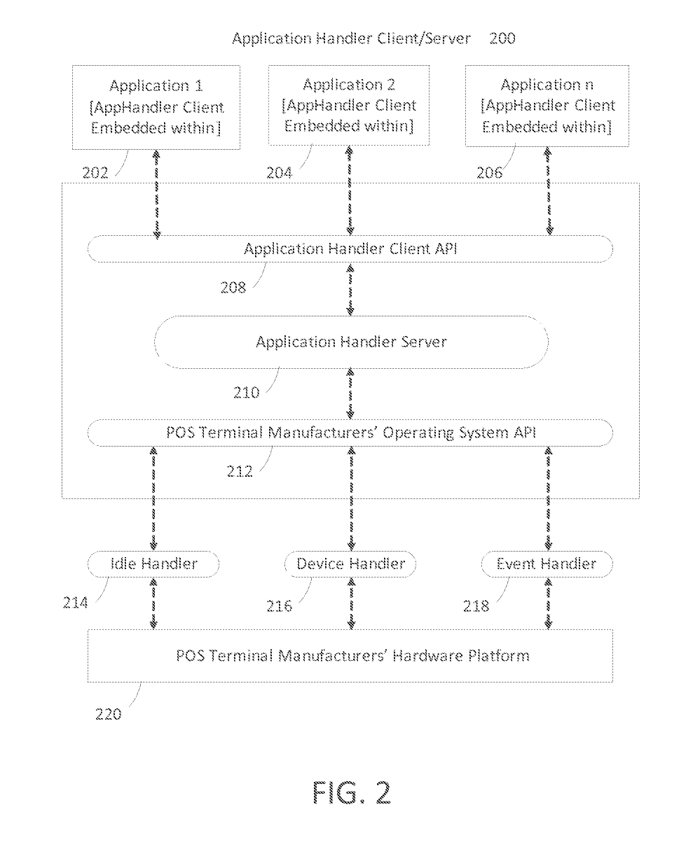

FIG. 2 is a block diagram of the common application architecture 200 in accordance with some embodiments. In some embodiments, the common application architecture may include different components. The present disclosure may use the terms such as Application Handler, App Handler, Server, Client, and other terms in any combination to describe the different components of the common application architecture. Such a common application architecture and the components therein may be implemented by one or more modules as described herein. Further, an application running on a POS device is implemented by modules described herein.

The AppHandler may implemented in at least two components, Server component 210 and Client component (202-206). The Client component (202-206) is embedded inside each application on the POS device that receives, sends, and processes requests from the Server component 210. Further, the Server component 210 is implemented on the POS device that sends, receives, and processes requests from the each of the application Client components (202-206). The interaction between the Server component 210 and Client components (202-206) coordinates the POS device hardware resources to achieve the functionality of running different applications, supporting different payment rendering mechanisms, implementing different security functions as well as other applications and functions known in the art.

Referring to FIG. 2, each Client component (202-206) is embedded in an application. Further, each Client component communicates with the AppHandler Server component 210 through an AppHandler Application Programming Interface (API) 208. In addition, the AppHandler Server component 210 communicates with the POS device hardware platform 220 through a POS device Operating System (OS) API and three further AppHandler components, Idle Handler 214, Device Handler 216, and Event Handler 218.

The AppHandler Server 210 implements several different functions such as the following: (a) Application initialization that sequences each application during initialization; (b) Application registration that collects registration information provided by applications; (c) Application enumerator that maintains a list of all executing applications and their current state; (d) Active Application that is of all the executing applications, there is only one application that is in the active state; (e) Application Idle Screen that determines if the Application Handler's idle screen is displayed; (f) Application Handler Idle Screen that determines if a particular application is responsible for displaying its idle screen; (g) Provide information to the application during runtime that sends asynchronous alerts to the applications during runtime; (h) Event Handler such that all communication is event-based, this removing platform dependencies; (i) Database that maintains databases for its Parameters and Alarms as described herein; (j) Parameters that are configuration parameters maintained in a Parameters database; (h) Alarms that are one-time and periodic alarms maintained in an Alarm database. Further, the AppHandler Client (202-206) implements several different functions such as the following: (a) Application information that provides information during initialization and registration; (b) Application selection that provides device entry events during user interaction; (c) Auto launch a function received from the Server and launches the application; (d) Activation Request that requests to be the activated application.

The Idle Handler 214, Device Handler 216, and Event Handler 218 components are Terminal Application Framework (TAF) library functions used by the AppHandler. TAF library functions may be used to implement certain function that may be required by the POS device. Further, TAF is a hardware abstraction layer that be laid over each manufacturer's POS device hardware operating system and defines a common Application Programming Interface (API) set for applications to execute functions, thereby allowing for a common application architecture across multiple manufacturer's POS device hardware. Thus, a single POS device application can be written to TAF on one POS device manufacturer's hardware and cross compiled to a different POS device manufacturer's hardware without changing any code, thereby reducing time to market of delivery of the same functionality across multiple POS device manufacturers' hardware. Further, the AppHandler has functions to process the events and activity captured and reported by each of these TAF library components. Each of these library components also serves has callbacks to act on requests from the AppHandler, as shown in the Figures herein.

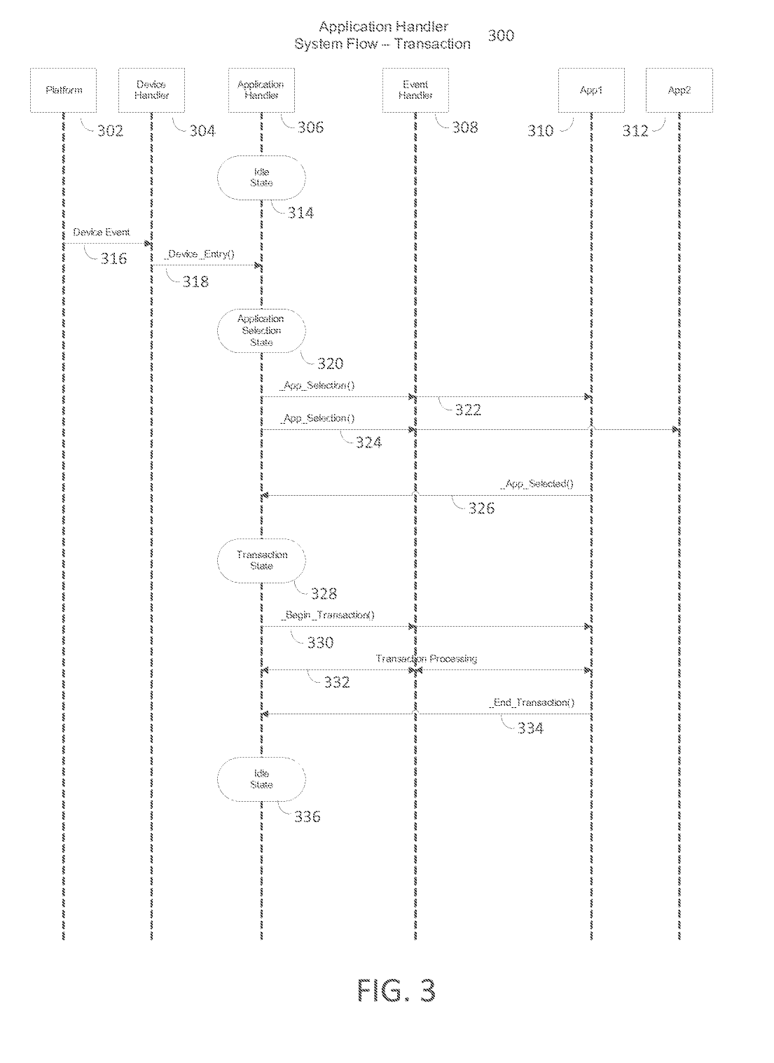

FIG. 3 is a flow diagram 300 of the common application architecture in accordance with some embodiments. The flow 300 is a timeline example of AppHandler 300 coordinating resource between two applications, AppHandler 300 is deciding on which of the two applications to execute based on input from a Device Handler 304 which represents an input device to the POS device (which could be a magnetic card reader, chip card reader, keypad button(s) entry, key press via touch screen, or from an attached peripheral [signature capture pad, check reader, barcode scanner, fingerprint scanner, or other]). The flow 300 includes three critical states of Idle State (314 and 336), Application Selection State 320, and Transaction State 328 that are implemented in the AppHandler 300. The AppHandler 300 is implemented as a state machine that moves between through these three states as either external or internal triggers occur, as described herein.

System flow 300 in FIG. 3 includes several components such as the hardware platform 302, Device Handler 304, Application Handler 306, Event Handler 308, a first application 310 and a second application 312. Further, the Application Handler 306 is in an Idle 314 state as described herein that includes monitoring different POS device components. While in the Idle state 314, the platform 302 triggers a Device Event transition from the platform 302 to the Device Handler 304 that may correspond to user input (e.g. magnetic swipe, pressing of keypad, touchscreen event, inserting a chip card, contactless event [tap] from a contactless card or mobile device or key fob, etc.). Further, the Device Handler 304 triggers a Device Entry event 318 to the Application Handler 306. The Application Handler 306 transitions from the Idle state 314 to the Application Selection state 320. In addition, the Application Selection state 320 may trigger two App Selection events, one for each application (322-324), to the Event Handler 308 that is forwarded to each respective application (310-312). The application that would be executed based on the Device event 316 (e.g. the first application 310) sends an App Selected event 326 back to the Application Handler 306. Moreover, the Application Handler transitions from the Application Selection state 320 to the Transaction state 328. Further, the Application Handler triggers a Begin Transaction event to the Event Handler 308 that is forwarded to the first application 310. In addition, a Transaction Processing event 330 is exchanged among the Application Handler 306, Event Handler 308 and first application 310. Application Handler 300 monitors the transaction. When processing of the transaction is complete, the first application 310 triggers an End Transaction event 334 to the Application Handler 306. In addition, the Application Handler 306 transitions from the Transaction state 328 back to the Idle state 336 to continue monitoring events to execute any other applications.

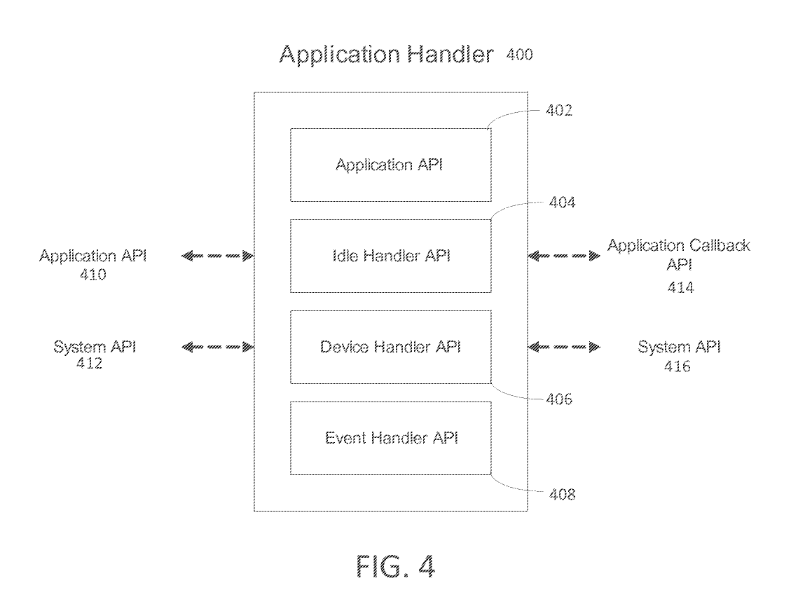

FIG. 4 is a block diagram of the common application architecture 400 in accordance with some embodiments. The common application architecture or AppHandler 400 includes four interface components that include Application Programming Interfaces (APIs), Idle Handler API, Event Handler API, Device Handler API, and the Application API. The Idle Handler API 404 may be used when the AppHandler 400 is in an Idle state monitoring for events (e.g. payment card swipe, keypad press, touchscreen event, inserting a chip card, contactless event [tap] from a contactless card or mobile device or key fob, etc.). Device Handler API 406 may be used communicate with the Device Handler to allocate device resources for certain applications. Event Handler API 408 may be used to communicate with the Event Handler used to process events received by the AppHandler 400. Further, the Application API 402 is AppHandler's functional layer such that applications on the POS terminal can call directly to engage with AppHandler functionality to coordinate between required resources or other applications. In addition, the AppHandler 400 receives events from either the POS operating system (OS), from the applications on the POS device, or from Devices on the POS (410, 412, and 416); and then processes these events to alert Applications on the POS or provides Device feedback 414 to manage the user experience when a user may be utilizing the POS device.

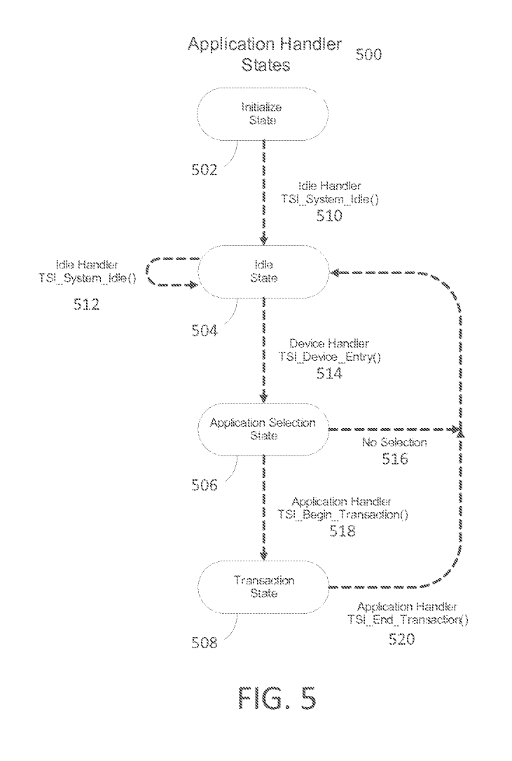

FIG. 5 is a state diagram 500 of the common application architecture in accordance with some embodiments. The common application architecture or AppHandler is implemented as a state machine 500. As shown in FIG. 5, the AppHandler traverses between four states, Initialize state 502, Idle state 504, Application Selection state 506, and Transaction state 508. On the initial power up of a POS device the AppHandler Initialization State 502 commences, such that the AppHandler engages with all the applications on the POS devices to understand their requirements for Application Selection and other library requirements, so in an operational mode Applications on the POS device can be properly selected at the right time and be confident their required resources are ready for use as needed.

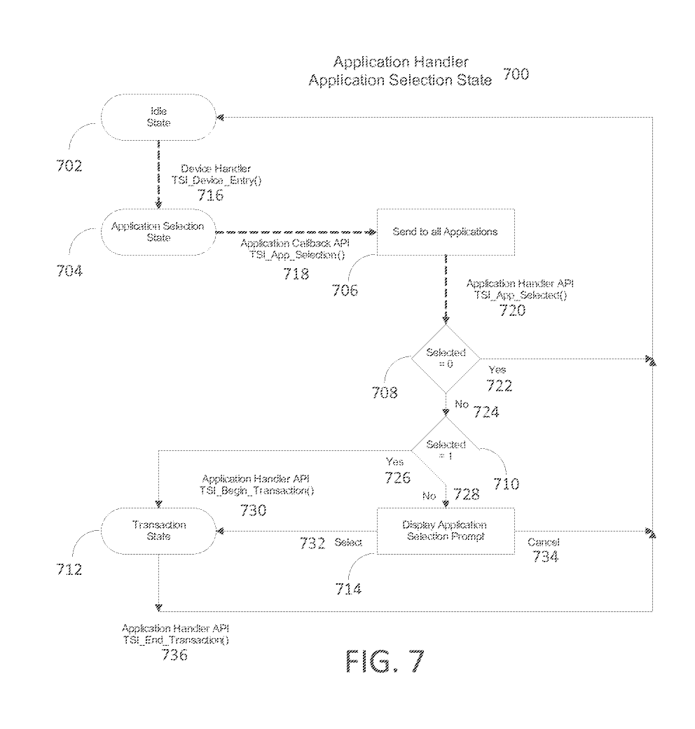

Following the Initialization State, the AppHandler enters into the Idle State 504 (through an event Idle Handler TSI System Idle 510), which is a state where the AppHandler is continually monitoring events (among other items) from POS devices (via Device Handler) awaiting e.g. input from a Key Button Press, Card Swipe, Card Insert, Card/Mobile Device/Key Fob Tap, input from a connected peripheral, or system / application alarm (through an event Idle Handler TSI System Idle 512). If input is received from any of the input devices, then the AppHandler processes the event (Device Handler TSI Device Entry 514), where most often the event is called for an Application on the POS device to be executed, and then the AppHandler enters the Application Selection state 506 to determine which of the multiple applications on the POS device should be executed. Upon determination of the Application to be executed, the AppHandler enters into the Transaction State where it passes control (through event Application Handler TSI Begin Transaction 518) to the Selected Application and monitor the lifecycle of the “transaction” through the states of the transaction within the Selected Application flow diagram (See FIG. 7). Thus, AppHandler transitions from the Application Selection state 506 to the Transaction state 508. Once the transaction is completed by the application, an Application TSI End Transaction event 520 triggers the AppHandler to transition from the Transaction state 508 to the Idle state 504. Further, while in the Application Selection state 506, no selection of an application can be made, such a No Selection event 516 triggers the AppHandler to transition from the Application Selection state 506 to the Idle state 504.

For example, if there are two applications on the POS device (e.g., a card payment application and a check processing application), and the incoming event is a card swipe, the AppHandler's Application Selection state processes this event and selects the card payment application because based on processing during the Initialization State, only the card payment application acts on a card swipe and uses the data of a card swipe, whereas the check application does not.

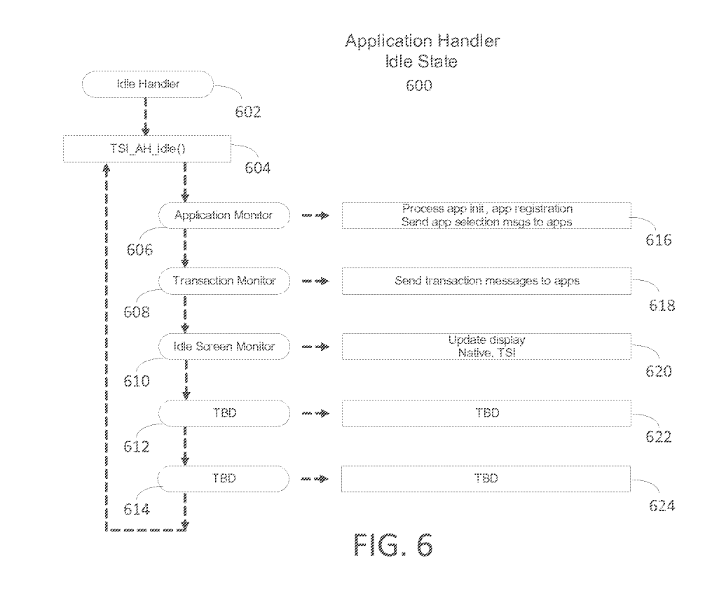

FIG. 6 is a block diagram of the Idle State monitoring of the common application architecture in accordance with some embodiments. Further, Idle state monitoring includes a “round robin”, cyclical monitoring approach that the Idle Handler (within AppHandler) uses to monitor the POS device when it is “idle”. During each of the steps shown in FIG. 6, the AppHandler's Idle Handler performs a number of functions polling the system for any events on which to act, and as needed during idle, performs necessary “housekeeping” functionality, e.g., updating the screen of the POS device with the proper idle prompts or display messaging. Such monitoring includes Application monitoring 606, transaction monitoring 608 and Idle Screen monitoring 610.

FIG. 7 is a flow diagram of the Application Selection flow of the common application architecture in accordance with some embodiments. The AppHandler's implementation of the Application Selection state, where if an event is received that requires an application on the POS device to be executed, the AppHandler Application Selection state functionality determines the correct application to be executed. During the AppHandler Initialization state, the AppHandler has gathered from the applications on the POS devices to understand their requirements for which input from the Device Handler to which they need to be invoked, and further how the input data should be qualified for each specific application on the POS device.

For example, if there are two applications on the POS device, e.g., a card payment application and a gift card application, and the incoming event is a card swipe where the card number matches the description of the Visa account number format, then the AppHandler's Application Selection state processes this event and selects the card payment application because it knows based on processing during the Initialization State that only the card payment application acts on a card swipe where the card number matches the description of the Visa account number format. Whereas the format used by a gift card would be different than the card account number format used by any of the payment card brands, e.g., Visa, Mastercard, Discover, American Express, JCB, and others.

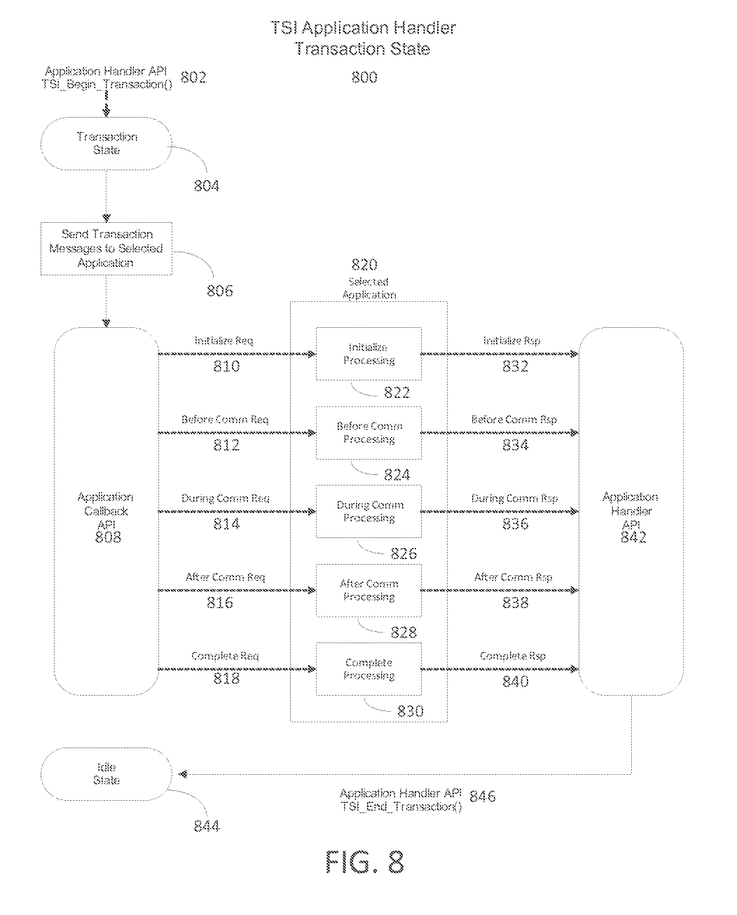

FIG. 8 is a flow diagram of the Transaction State of the common application architecture in accordance with some embodiments. When in the Transaction State, the AppHandler is monitoring the lifecycle of a “transaction”, where the transaction is managed and executed by an application that exists on the POS device. Any application on the POS device has implemented the specifics of the business logic associated with its application; and it has implemented these specifics in an manner in accordance with the AppHandler architecture that calls for the application to be implemented as a state machine with the following states (as noted in the above figure): Initialize 822, Before Comm 824, During Comm 826, After Comm 828, and Complete Processing 830. Additionally, there are two other state requirements of an application which are Registration and Deactivation. The AppHandler in the Transaction State monitors the POS device events and perform “checks and balances” in between the aforementioned application states.

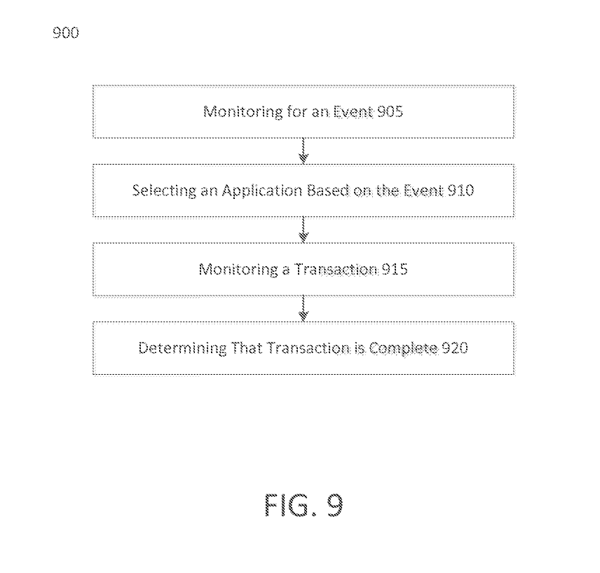

FIG. 9 is a flowchart if a method implementing a common application architecture on multiple point-of-sale hardware platforms to support multiple applications in accordance with some embodiments. The method 900 includes monitoring, by one or more common application modules on a POS device, for an event, as shown in block 905. Further, the method includes selecting, by the one or more common application modules, an application based on the event, as shown in block 910. In addition, the method includes monitoring, by the one or more common application modules, a transaction implemented by the application based on the event, as shown in block 915. The monitoring for the event is performed when the one or more common application modules are in an idle state. The selecting of the application based on the event is performed when the one or more common application modules are in an application selection state. The monitoring transaction is performed when the one or more common application modules are in a transaction state. Moreover, the method 900 includes determining that the transaction is complete, as shown in block 920. The one or more common application modules transition from a transaction state to an idle state when the transaction is complete. The one or more common application modules are configured to function with one or more POS hardware platforms.

Note, the pending disclosure discusses several different POS terminals/devices that implement different functions. However, persons of ordinary skill in the art understand such functions may be implemented within one POS terminal or implemented across a plurality of POS terminals. Such POS devices include storage devices or memory as well as one or more processors that may implement modules described herein. Further, the term “Handler” may be used to describe a module as described herein. In addition, applications and APIs may also be implemented by modules as described herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
monitoring, by one or more common application modules on a point-of-sale device, for an event;
selecting, by the one or more common application modules, an application based on the event;
monitoring, by the one or more common application modules, a transaction implemented by the application based on the event;
wherein the one or more common application modules are configured to function with one or more POS hardware platforms.

2. The method of claim 1, wherein the monitoring for the event is performed when the one or more common application modules are in an idle state.

3. The method of claim 1, wherein the selecting of the application based on the event is performed when the one or more common application modules are in an application selection state.

4. The method of claim 1, wherein the monitoring transaction is performed when the one or more common application modules are in a transaction state.

5. The method of claim 1, further comprising determining that the transaction is complete.

6. The method of claim 5, wherein the one or more common application modules transition from a transaction state to an idle state when the transaction is complete.

7. A point-of-sale (POS) device, comprising:
a storage device;
a processor coupled to the storage device, the processor configured to:
implement one or more common application modules and one or more application modules;
embed and implement a common application client module within an application module;
implement a common application server module that communicates with the common application client module through a common application client application programming interface (API);
implement an idle handler module, a device handler module, and an event handle module each communicating between a POS device hardware platform and the common application server module through a POS device operating system (OS) API;
wherein the one or more common application modules are configured to function with one or more POS hardware platforms.

8. The POS device, wherein the common application server module is configured to:
monitor for an event;
select an application based on the event;
monitor, the common application client module, a transaction implemented by the application based on the event.

9. The POS device of claim 8, wherein monitoring for the event is performed when the common application server module is in an idle state.

10. The POS device of claim 8, wherein selecting of the application based on the event is performed when the common application server module is in an application selection state.

11. The POS device of claim 8, wherein monitoring transaction is performed when the common application server module is in a transaction state.

12. The POS device of claim 8, further comprising determining, by the common application server module that the transaction is complete.

13. The POS device of claim 12, wherein the common application server module transitions from a transaction state to an idle state when the transaction is complete.
